(19) United States
(12) Patent Application Publication
(10) Pub. No.: US 2012/0299383 A1
(43) Pub. Date: Nov. 29, 2012

(54) POWER DISTRIBUTION SYSTEM

(75) Inventors: Takaaki Cyuzawa, Osaka (JP); Mikio Shinagawa, Osaka (JP)

(73) Assignee: PANASONIC ELECTRIC WORKS CO., LTD, OSAKA (JP)

(21) Appl. No.: 13/381,158

(22) PCT Filed: Jun. 8, 2010
(86) PCT No.: PCT/JP2010/059714

§ 371 Date: Aug. 17, 2012

(30) Foreign Application Priority Data
Jun. 30, 2009 (JP) 2009-156110

(51) Int. Cl. H02J 4/00

(52) U.S. Cl. 307/75

(57) ABSTRACT

A system coordination unit 1 includes a reverse power flow prevention circuit 10. When power output from a fuel cell 6 and/or a secondary cell 7 exceeds power consumed in AC loads and DC loads, the reverse power flow prevention circuit 10 prevents a reverse flow of excess power into a commercial power source 4. The reverse power flow prevention circuit 10 is interposed in an AC main power path 20 between a connection point of a solar cell 5 and the AC main power path 20 and each of a connection point of a fuel cell 6 and the AC main power path 20 and a connection point of a secondary cell 7 and the AC main power path 20. The reverse power flow prevention circuit 10 compares the power output from the fuel cell 6 and/or the secondary cell 7 with the power consumed in the AC loads and the DC loads. Upon determining that the former power is not less than the latter power, the reverse power flow prevention circuit 10 electrically interrupts the AC main power path 20. Consequently, the reverse power flow of the power generated by the fuel cell 6 and/or the secondary cell 7 into the commercial power source 4 is prevented by making use of only one reverse power flow prevention circuit 10. Therefore, in comparison with a case where each distributed power source other than a solar cell 5 is provided with a reverse current flow prevention device, the system can be implemented at a low cost.

### TECHNICAL FIELD

The present invention relates to a power distribution system employing a solar cell and a distributed power source other than a solar cell.

### BACKGROUND ART

In the past, there has been a system which includes a solar cell connected to a commercial power source in parallel and performs system coordination operation of supplying power to loads from the commercial power source and the solar cell. Such a system is well known as a power distribution system adopting a solar cell as a distributed power source. In such a power distribution system, during the daytime, the solar cell can generate sufficient power, and therefore generated power of the solar cell is likely to exceed consumed power and cause an excess (hereinafter referred to as “excess power”) of power. In this situation, this power distribution system can sell the excess power to a power company by feeding the excess power to the commercial power system (cf., JP 2003-189477 A).

Recently, the power distribution system which further includes a distributed power source (e.g., a fuel cell and a secondary cell) other than a solar cell has been provided. Besides, in this power distribution system, a power storage device is also treated as a type of the distributed power source. According to this power distribution system, the distributed power source can provide enough power to loads even during night that the solar cell would generate lowered power.

However, currently in Japan, in consideration of adverse effect on a commercial power system, selling electric power is allowed only with regard to a solar cell. In brief, with regard to a distributed power source (e.g., a fuel cell and a secondary cell) other than a solar cell, selling electric power is not allowed. Therefore, “guideline for technical requirements for interconnection regarding ensuring power quality” stipulates that even if surplus power is produced by a fuel cell and a secondary cell, the surplus power should not flow into the commercial power system. Generally, a distributed power source (e.g., a fuel cell and a secondary cell) other than a solar cell is individually provided with a reverse power flow prevention device for preventing a reverse power flow.

When the power distribution system includes plurality distributed power sources other than a solar cell, and when each distributed power source (e.g., a fuel cell and a secondary cell) other than a solar cell is provided with a reverse power flow prevention device, the power distribution system includes the multiple reverse power flow prevention devices as a whole. The reverse power flow prevention device has a complicated construction for protection of the commercial power system. Therefore, addition of plural reverse power flow prevention devices prevents lowering a cost for implementing the power distribution system.

### DISCLOSURE OF INVENTION

In view of the above insufficiency, the present invention has been aimed to propose a power distribution system which can be implemented at a lowered cost in comparison with a configuration where each distributed power source other than a solar cell is provided with a reverse power flow prevention device.

The power distribution system in accordance with the present invention includes: a first distributed power source defined as a solar cell; a second distributed power source including a plurality of distributed power sources other than the first distributed power source; and a main power path adapted for supplying power to a load and connected to the first distributed power source, the second distributed power source, and a commercial power source. The first distributed power source is connected to the main power path at a connection point between a connection point of the commercial power source and the main power path and a connection point of the second distributed power source and the main power path. The power distribution system further includes a reverse power flow prevention circuit interposed in the main power path between the connection point of the first distributed power source and the main power path and the connection point of the second distributed power source and the main power path, and configured to interrupt the main power path in response to occurrence of excess power in the distributed power source.

According to the above configuration, in contrast to a situation where each distributed power source other than the solar cell is provided with a reverse current flow prevention device, whereby the power distribution system can be implemented at a lowered cost.

In this power distribution system, preferably, the main power path includes an AC main power path adapted for supplying AC power to an AC load and a DC main power path adapted for supplying DC power to a DC load. The power distribution system further comprises a power conversion circuit interposed between the AC main power path and the DC main power path, the power conversion circuit being configured to convert an alternate current supplied from the AC main power path to a direct current to be supplied to the DC main power path. The first distributed power source is connected to the DC main power path without passing through the power conversion circuit.

### BRIEF DESCRIPTION OF DRAWINGS

FIG. 1 is a schematic diagram illustrating the configuration of the power distribution system in accordance with the first embodiment,

FIG. 2 is a schematic diagram illustrating the configuration of the power distribution system in accordance with the second embodiment,

FIG. 3 is a schematic diagram illustrating the configuration of the power distribution system in accordance with the third embodiment, and

FIG. 4 is a schematic diagram illustrating the configuration of the power distribution system in accordance with the fourth embodiment.

### BEST MODE FOR CARRYING OUT THE INVENTION

### First Embodiment

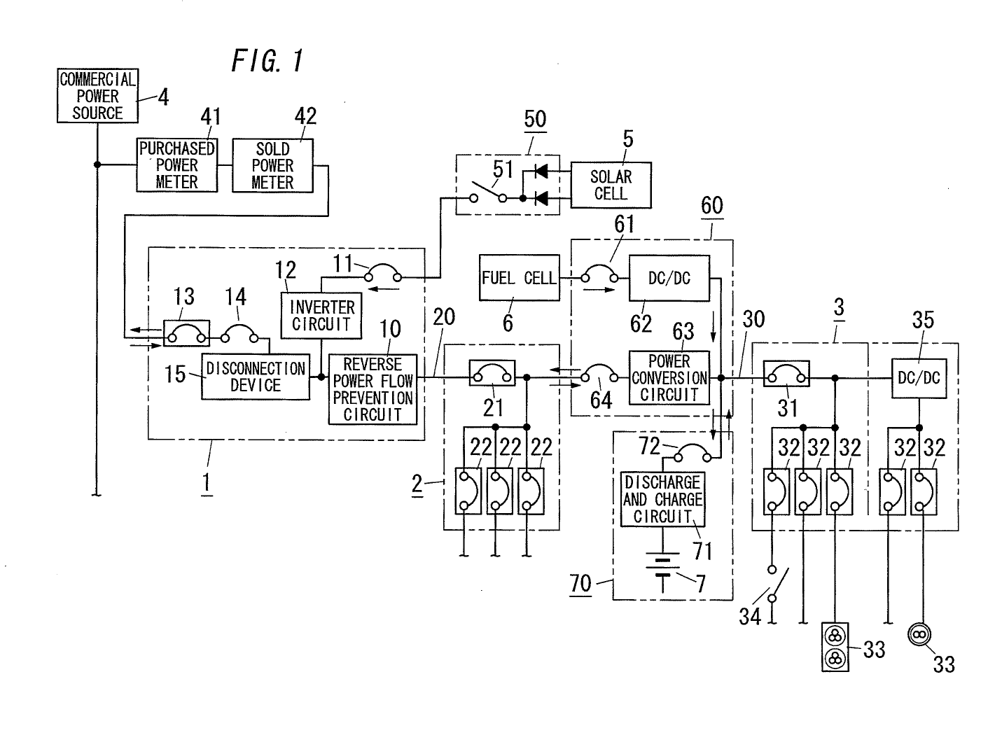

As shown in FIG. 1, the power distribution system of the present embodiment is used for distributing power to loads (electric devices) installed in a residence, and includes an AC distribution board 2 and a DC distribution board 3. The AC distribution board 2 is placed in a predetermined position in the residence, and is configured to supply AC power to an AC powered load (hereinafter, referred to as “AC load”). The DC distribution board 3 is placed in a predetermined position in the residence, and is configured to supply DC power to a DC powered load (hereinafter, referred to as “DC load”).

The AC distribution board 2 is configured to accommodate a main breaker 21 being an earth leakage circuit breaker, and a plurality of branch breakers 22. Connecting a load circuit used in AC power to the branch breaker 22 enables supplying AC power to an AC load (not shown). The main breaker 21 is interposed in the AC main power path 20 connected to a commercial power source 4. Each branch breaker 22 is connected to a secondary side terminal of the main breaker 21. Besides, the above load circuit includes a wiring device (e.g., an AC outlet adapted to be installed in a room, and a wall switch) and a lighting fixture, for example. The commercial power source 4 is adapted to be used in a single-phase three-wire system. The commercial power source 4 is connected to the main breaker 21 by use of the AC main power path 20 composed of three lines including a neutral line and a pair of voltage lines.

Each branch breaker 22 includes power terminals (not shown), and is electrically connected to the main breaker 21 in such a manner that the power terminals are respectively connected to only two of the three lines (neutral line and paired voltage lines) via the secondary side terminal of the main breaker 21. When being connected to the neutral line and any one of the voltage lines, the branch breaker 22 receives an AC voltage of 100 V. When being connected to the paired voltage lines, the branch breaker 22 receives an AC voltage of 200 V. In addition, each branch breaker 22 includes a load terminal (not shown) adapted in use to be connected to a load circuit, and contact points (not shown) interposed between its power terminal and its load terminal. The branch breaker 22 turns on and off power supply to the corresponding load circuit by opening and closing its contact points.

The power distribution system of the present embodiment includes a solar cell 5, a fuel cell 6, and a secondary cell 7 as a distributed power source. The solar cell 5 defines a first distributed power source, and the fuel cell 6 and the secondary cell 7 define a second distributed power source.

The solar cell 5 is connected to the AC main power path 20 by way of a connection box 50, a switch 11, and an inverter circuit 12 configured to convert a direct current to an alternate current. The connection box 50 includes an array switch 51 and is configured to collect electrical power generated at the solar cell 5. The inverter circuit 12 is connected to primary side terminals (terminals for connection with the commercial power source 4) of the main breaker 21 via the AC main power path 20. The inverter circuit 12 converts the output voltage of the solar cell 5 to an AC voltage of the same voltage value and frequency as an output voltage of the commercial power source 4. The resultant AC voltage is applied to an AC load via the AC distribution board 2. Besides, the switch 11 and the inverter circuit 12 constitute a system coordination unit 1 in cooperation with an entrance device 13 or the like. The entrance device 13 is used for connecting the commercial power source 4 to the AC main power path 20.

In this power distribution system, during the daytime, the solar cell 5 can generate sufficient power, and therefore the generated power of the solar cell 5 is likely to exceed the power consumed in loads and cause an excess (hereinafter referred to as “excess power”) of power. This power distribution system is configured to supply the excess power to the commercial power system in order to sell the excess power to a power company. Therefore, a purchased power meter 41 and a sold power meter 42 are interposed between the commercial power source 4 and the system coordination unit 1. The purchased power meter 41 is configured to measure power supplied from the commercial power source 4 to a consumer. The soled power meter 42 is configured to measure power fed from the consumer to the commercial power source 4.

The DC distribution board 3 is configured to accommodate a main breaker 31 being an earth leakage circuit breaker, and a plurality of branch protectors 32. The main breaker 31 is interposed in the DC main power path 30 connected to the fuel cell 6 and the secondary cell 7. Each branch protector 32 is connected to a secondary side terminal of the main breaker 31. The fuel cell 6 is connected to a primary side terminal of the main breaker 31 via a switch 61 and a DC/DC converter 62. The secondary cell 7 is connected to the primary side terminal of the main breaker 31 via a discharge and charge circuit 71 and a switch 72. The discharge and charge circuit 71 is configured to discharge and charge the secondary cell 7. The secondary cell 7 constitutes a power storage unit 70 in cooperation with the discharge and charge circuit 71 and the switch 72.

Therefore, connecting a load circuit used in DC power to the branch protector 32 enables supplying DC power to a DC load (not shown) from at least one of the fuel cell 6 and the secondary cell 7. Besides, the above load circuit includes a wiring device (e.g., a DC outlet 33 and a wall switch 34) and a lighting fixture, for example. The DC outlet 33 includes a pair of feeding portions (a positive electrode and a negative electrode), and is adapted to be placed in a room. The branch protector 32 is configured to monitor a current passing through the corresponding load circuit. Upon detecting a malfunction (e.g., short circuit), the branch protector 32 lowers power supplied to the corresponding DC load or terminates supplying power to the corresponding DC load.

The DC load is classed into a high voltage DC load and a low voltage DC load. The high voltage DC load is defined as a device operating with relatively high voltage (e.g., 300 V), such as an air conditioner and a refrigerator. The low voltage DC load is defined as a device operating with relatively low voltage (e.g., 48 V), such as a telephone, a personal computer, and a liquid crystal television. Hence, the DC distribution board 3 includes a DC/DC converter 35 for lowering voltage. The low voltage DC load is connected to an output terminal of the DC/DC converter 35 via the branch protector 32.

The DC main power path (a path connected to the primary side terminal of the main breaker 31) and the AC main power path (a path connected to the secondary side terminal of the main breaker 21) 20 are connected to each other via a power conversion circuit 63. The power conversion circuit 63 is connected to the AC man power path 20 via a switch 64. The power conversion circuit 63 is configured to convert AC to DC and DC to AC. The power conversion circuit 63 is configured to convert AC power received from the AC main power path 20 to DC power and then output the resultant DC power to the DC main power path 30. Further, the power conversion circuit 63 is configured to convert DC power received from the DC main power path 30 to AC power and then output the resultant AC power to the AC main power path 20. Consequently, when the commercial power source 4 and the solar cell 5 fail to supply sufficient power to the AC load by themselves, the fuel cell 6 and the secondary cell 7 can supplement the power required by the AC load. Meanwhile, when the fuel cell 6 and the secondary cell 7 fail to supply sufficient power to the DC load by themselves, the commercial power source 4 and the solar cell 5 can supplement the power required by the DC load. The power conversion circuit 63 and the switch 64 constitute a converter unit 60 in cooperation with the DC/DC converter 62 and the switch 61 for the fuel cell 6.

The power distribution system which has the configuration explained in the above includes a control unit (not shown) configured to control power obtained from each of the solar cell 5, the fuel cell 6, and the secondary cell 7. The control unit is configured to receive load information including consumed power, and is configured to turn on and off each of the switches 11, 61, 64, and 72 independently. The switch 11 is interposed between the solar cell 5 and the main power path 20, 30. The switch 61 is interposed between the fuel cell 6 and the main power path 20, 30. The switch 72 is interposed between the secondary cell 7 and the main power path 20, 30. The switch 64 is interposed between the power conversion circuit 64 and the AC main power path 20. For example, during the daytime that the solar cell 5 can generate sufficient power, the control unit keeps turning off the switch 61 of the switches 11, 61, 64, and 72, thereby separating the fuel cell 6 from the DC main power path 30. Hence, the power generated by the solar cell 5 is supplied to loads in preference to the other distributed power sources. In this situation, the control unit controls the discharge and charge circuit 71 in such a manner to charge up the secondary cell 7 with output from the solar cell 5. Meanwhile, during the night that the solar cell 5 would fail to generate sufficient power, the control unit keeps turning on the switch 61, thereby connecting the fuel cell 6 to the DC main power path 30. Hence, the power generated by the fuel cell 6 is supplied to loads in preference to the other distributed power sources. In this situation, the control unit controls the discharge and charge circuit 71, thereby discharging the secondary cell 7 in order to cover a shortage occurring when the fuel cell 6 fails to provide sufficient power by itself.

Consequently, the power distribution system can provide as much power as required by the loads in a residence from the distributed power sources (the solar cell 5, the fuel cell 6, and the secondary cell 7) without using the power supplied from the commercial power source 4. Further, the control unit is configured to turn off the switch 11 corresponding to the solar cell 5, upon detecting a malfunction of the solar cell 5. The control unit is configured to turn off the switch 61 corresponding to the fuel cell 6, upon detecting a malfunction of the fuel cell 6. Hence, the control unit has a function of protect the commercial power system from adverse effect caused by the malfunction of the solar cell 5 and/or the fuel cell 6.

Besides, in this power distribution system, the system coordination unit 1 includes a disconnection device 15 for separating the distributed power sources (the solar cell 5, the fuel cell 6, and the secondary cell 7) from the commercial power source 4 in response to occurrence of a power failure (outage) of the commercial power source 4. The disconnection device 15 is configured to turn off (open) a switch 14, upon detecting islanding operation of the distributed power sources. The switch 14 is interposed between the entrance device 13 and the AC main power path 20. Consequently, when the power failure of the commercial power source 4 occurs, the commercial power source 4 is separated from the AC main power path 20 in the system coordination unit 1. Therefore, the AC loads and the DC loads are energized by the distributed power sources and then operate. In the instance shown in FIG. 1, the AC main power path 20 is defined as a path between the disconnection device 15 and the power conversion circuit 63, and the DC main power path 30 is defined as a path between the power conversion circuit 63 and the DC/DC converter 35.

Moreover, in the power distribution system of the present embodiment, the system coordination unit 1 includes a reverse power flow prevention circuit 10. The reverse power flow prevention circuit 10 is configured to prevent a reverse flow of the excess power into the commercial power source 4, when the fuel cell 6 and/or the secondary cell 7 outputs the power exceeding the power consumed in the AC loads and the DC loads. Currently in Japan, power generated by the solar cell 5 is allowed to be sold, but power generated by the distributed power source (e.g., the fuel cell 6 and the secondary cell 7) other than the solar cell 5 is prohibited to be sold. Therefore, the reverse power flow prevention circuit 10 is provided for preventing the reverse flow of power generated by the fuel cell 6 and/or the secondary cell 7.

When power output from the fuel cell 6 and/or the secondary cell 7 exceeds power consumed in the AC loads and the DC loads in the residence, it can be assumed that the excess power is generated in the fuel cell 6 and/or the secondary cell 7. On the basis of the above assumption, the reverse power flow prevention circuit 10 is interposed in the AC main power path 20 between a connection point of the inverter circuit 12 for the solar cell 5 and the AC main power path 20 and a connection point of the AC distributed power board 2 and the AC main power path 20. Further, the reverse power flow prevention circuit 10 is configured to compare the power output from the fuel cell 6 and/or the secondary cell 7 with the power consumed in the AC loads and the DC loads. The reverse power flow prevention circuit 10 is configured to, upon judging that the power output from the fuel cell 6 and/or the secondary cell 7 is not less than the power consumed in the AC loads and the DC loads, determine the generation of the excess power and then electrically separate the AC distributed board 2 from the commercial power source 4. Accordingly, it is possible to prevent the reverse flow of the power generated by the fuel cell 6 and/or the secondary cell 7 into the commercial power source 4.

Alternatively, the reverse power flow prevention circuit 10 may be configured to, upon determining the generation of the excess power in the fuel cell 6 and/or the secondary cell 7, connect a load (hereinafter referred to as “spare load”) to a part of the AC main power path 20 close to the AC distributed board 2. Consequently, the excess power produced by the fuel cell 6 and/or the secondary cell 7 is supplied to the spare load, and then is consumed in the spare load. Therefore, it is possible to make efficient use of the excess power. For example, when the spare load is a heater for heating water, the excess power can be used as thermal energy in the residence.

According to the above explained configuration, the reverse power flow from the plural distributed power sources (the fuel cell 6 and the secondary cell 7) can be prevented by use of the only one reverse power flow prevention circuit 10. The reverse power flow prevention circuit 10 is interposed in the AC main power path 20 downstream of the connection point of the solar cell 5 and the AC main power path 20 and upstream of the connection point of the distributed power source (e.g., the fuel cell 6 and the secondary cell 7) and the AC main power path 20. Therefore, the reverse power flow prevention circuit 10 can prevent all the reverse power flow from the distributed power sources other than the solar cell 5, yet allowing the reverse power flow from the solar cell 5. Consequently, the power distribution system can reduce the number of the reverse power flow prevention circuits thereof, in contrast to a situation where each distributed power source other than the solar cell 5 is provided with a reverse current flow prevention device, whereby the power distribution system can be implemented at a lowered cost.

Besides, the present embodiment exemplifies the power distribution system which has the second distributed power source including the fuel cell 6 and the secondary cell 7, but is not limited to the above explained instance. For example, the power distribution system may have the second distributed power source including plural fuel cells 6, plural secondary cells 7, plural other distributed power sources (other than solar cells 5), or a combination thereof.

### Second Embodiment

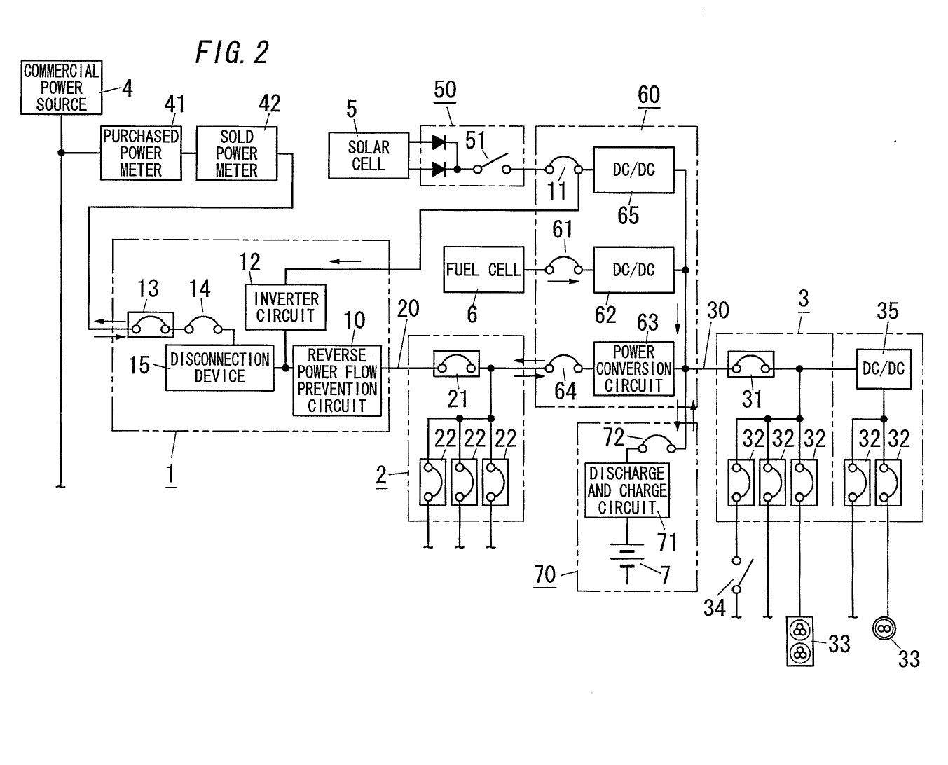

As shown in FIG. 2, the power distribution system of the present embodiment is different from the power distribution system of the first embodiment in that the solar cell 5 is connected to the DC main power path 30 without passing through the power conversion circuit 63.

In the present embodiment, the solar cell 5 is connected to a DC/DC converter 65 via the connection box 50 and the switch 11. The DC/DC converter 65 has its output terminal connected to the primary side terminal of the main breaker 31 of the DC distributed board 3. Further, the solar cell 5 is also connected to the inverter circuit 12 of the system coordination unit 1 via the switch 11 without passing through the DC/DC converter 65.

In the present embodiment, the control unit may be configured to keep turning off the switch 64 between the power conversion circuit 63 and the AC main power path 20 so as to separate the AC main power path 20 from the DC main power path 30 during the daytime that the solar cell 5 would generate sufficient power. With this arrangement, the power generated by the solar cell 5 can be supplied to both the AC load and the DC load.

According to the above explained configuration, the DC power generated by the solar cell 5 can be supplied directly to the DC main power path 30. Therefore, in contrast to a situation where the DC power generated by the solar cell 5 is converted to AC power by the inverter circuit 12 and subsequently is converted to DC power by the power conversion circuit 63, it is possible to reduce power conversion loss.

The other components and functions of the present embodiment are same as those of the first embodiment.

### Third Embodiment

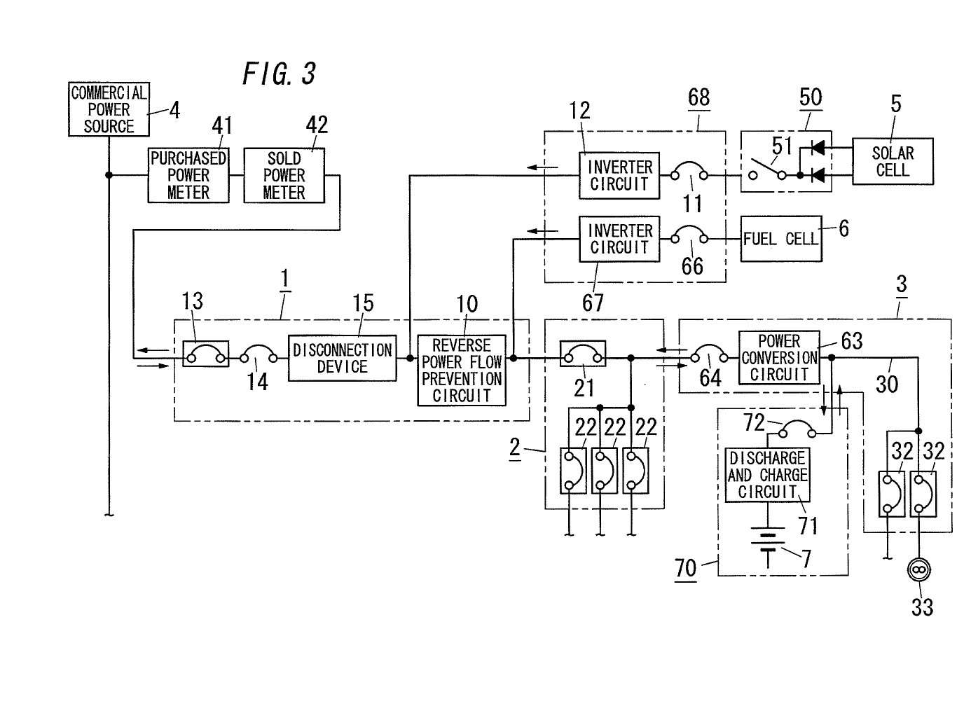

As shown in FIG. 3, the power distribution system of the present embodiment is different from the power distribution system of the first embodiment in that the fuel cell 6 is connected to the AC main power path 20 without passing through the power conversion circuit 63.

In the present embodiment, the fuel cell 6 is connected to an inverter circuit 67 via a switch 66. The inverter circuit 67 is configured to convert DC supplied from the fuel cell 6 to AC to be supplied to the AC main power path 20. The inverter circuit 67 has its output terminal connected to the primary side terminal of the main breaker 21 of the AC distributed board 2. In brief, the reverse power flow prevention circuit 10 is interposed in the AC main power path 20 between the connection point of the solar cell 5 and the AC main power path 20 and the connection point of the fuel cell 6 and the AC main power path 20. The switch 11 and the inverter circuit 12 for the solar cell 5 are separated from the system coordination unit 1 and constitute the inverter unit 68 in cooperation with the switch 66 and the inverter circuit 67 for the fuel cell 6.

Further, the present embodiment is designed to supply power to only the low voltage DC loads of the DC loads. Therefore, the DC distributed board 3 is devoid of the DC/DC converter 35, and the present embodiment is configured to supply the output power from the power conversion circuit 63 to the low voltage DC load via the branch protector 32. Besides, in the instance shown in FIG. 3, the converter unit 60 is optional, and the power conversion circuit 63 and the switch 64 are housed in the DC distributed board 3.

According to this configuration, for example, even when the power conversion circuit 63 malfunctions, the power distribution system can supply the power generated by the solar cell 5 and/or the fuel cell 6 to the AC main power path 20, thereby providing as much power as required from loads in the residence without using the power supplied from the commercial source 4.

The other components and functions of the present embodiment are same as those of the first embodiment.

### Fourth Embodiment

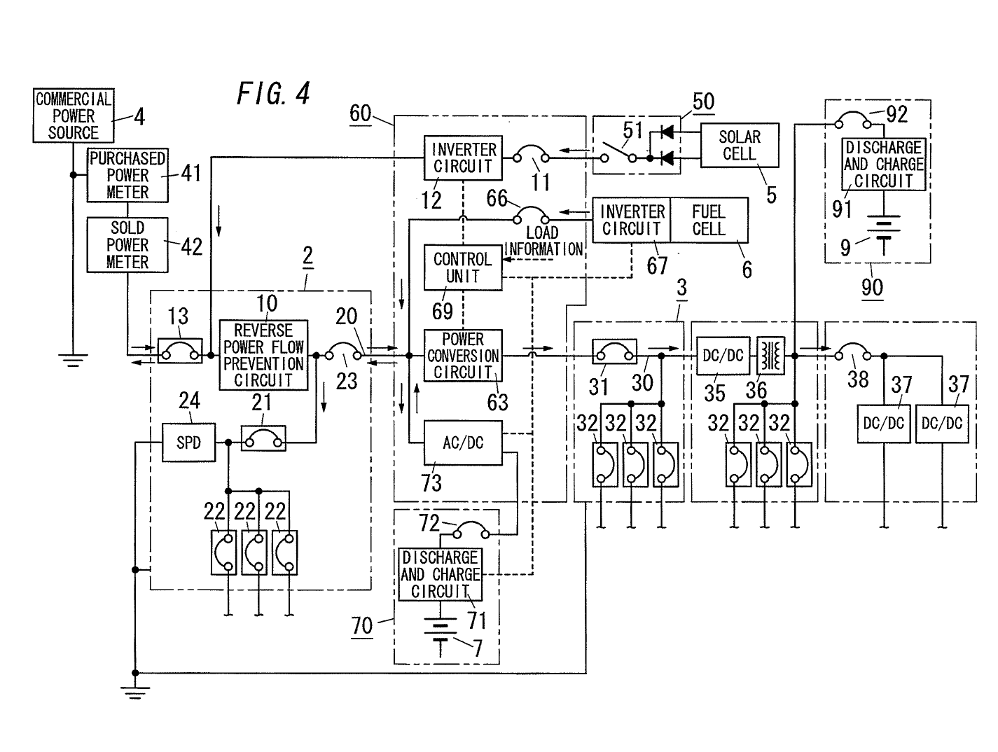

As shown in FIG. 4, the power distribution system of the present embodiment is different from the power distribution system of the first embodiment in that the present embodiment includes an emergency power storage unit 90 in addition to the power storage unit 70. The emergency power storage unit 90 includes a secondary cell 9, a discharge and charge circuit 91, and a switch 92.

In the present embodiment, the low voltage DC load is defined as an emergency load (e.g., an emergency lamp) configured to be kept being turned on even during the power failure of the commercial power source 4. The present embodiment includes the emergency power storage unit 90 in order to successfully provide power used for operating the emergency load during the power outage of the commercial power source 4. A safety isolating transformer 36 is interposed in the DC main power path 30 between the DC/DC converter 35 and the branch protectors 32 which is adapted in use to be connected to the low voltage DC loads. The emergency power storage unit 90 is connected to a secondary side terminal of the safety isolating transformer 36 by way of the DC main power path 30.

In the present embodiment, the low voltage DC load includes a load configured to operate with an operating voltage (e.g., 24 V, 12 V, and 5 V) lower than the output voltage (e.g., 48 V) of the DC/DC converter 35. Such a load is connected to the safety isolating transformer 36 via a DC/DC converter 37 which is configured to lower the output voltage from the secondary side terminal of the safety isolating transformer 36 into the operating voltage of the load. There is a switch 38 interposed between the safety isolating transformer 36 and each DC/DC converter 37. In the instance shown in FIG. 4, the DC main power path 30 is defined as a path between the power conversion circuit 63 and the DC/DC converter 37. Besides, the circuit connected to the secondary side terminal of the safety isolating transformer 36 acts as a safety extra-low voltage (SELV) circuit.

Further, the fuel cell 6 and the power storage unit 70 are connected to the AC main power path 20 without passing through the power conversion circuit 63. For example, the inverter circuit 67 is attached to the fuel cell 6, and is configured to convert DC power output from the fuel cell 6 to AC power to be output to the AC main power path 20. The inverter circuit 67 has its output terminal connected to the AC main power path 20 via the switch 66. The power storage unit 70 is connected to the AC main power path 20 via an AC/DC converter 73 configured to convert AC supplied from the AC main power path 20 to DC to be supplied to the power storage unit 70 and to convert DC supplied from the power storage unit 70 to AC to be supplied to the AC main power path 20. In the present embodiment, the power conversion circuit 63 of the converter unit 60 is configured to convert AC to DC but is not configured to convert DC to AC. Besides, in the instance shown in FIG. 4, the system coordination unit 1 is optional, and the switch 11 and the inverter circuit 12 for the solar cell 5 constitute the converter unit 60 in cooperation with the AC/DC converter 73 for the power storage unit 70 and the power conversion circuit 63.

The converter unit 60 includes a control unit 69 configured to control the inverter circuit 12 for the solar cell 5, the inverter circuit 67 for the fuel cell 6, the AC/DC converter 73 for the power storage unit 70, the discharge and charge circuit 71, and the power conversion circuit 63. The control unit 69 is configured to receive the load information including the consumed power, and is configured to adjust the power obtained from each of the solar cell 5, the fuel cell 6, and the secondary cell 7.

The entrance device 13 and the reverse power flow prevention circuit 10 are housed in the AC distributed board 2, and are connected to an AC input terminal of the power conversion circuit 63 via a primary side power transfer breaker 23. The main breaker 21 of the AC distributed board 2 is connected between the reverse power flow prevention circuit 10 and the primary side power transfer breaker 23. A serge protector 24 is interposed between the ground and a connection point of the main breaker 21 and the branch breaker 22. Besides, the disconnection device 15 is not shown in FIG. 4.

According to the above configuration, the power distribution system keeps the emergency power storage unit 90 almost fully charged during normal time, and discharges the emergency power storage unit 90 only during the power failure of the commercial power source 4. Therefore, it is possible to successfully reserve power in the emergency power storage unit 90 for operating the low voltage DC load during the power failure of the commercial power source 4. Moreover, the emergency power storage unit 90 is directly connected to the DC main power path 30. Therefore, the power distribution system can efficiently supply power to the low voltage DC load without causing loss accompanying power conversion between DC and AC. Consequently, the power storage unit 70 need not reserve power for operating the low voltage DC load during the power outage of the commercial power source 4. With charging the power storage unit 70 during a time period that power consumption is relatively low, and discharging the power storage unit 70 during a time period that power consumption is relatively high, the power storage unit 70 can be utilized for load leveling.

Besides, the emergency power storage unit 90 is preferred to be placed adjacent to the low voltage DC load. In this instance, it is possible to reduce power loss caused by the DC main power path 30 between the emergency power storage unit 90 and the low voltage DC load.

The other components and functions of the present embodiment are same as those of the first embodiment.

1. A power distribution system comprising:
a first distributed power source defined as a solar cell;
a second distributed power source including a plurality of distributed power sources other than said first distributed power source; and
a main power path adapted for supplying power to a load and connected to said first distributed power source, said second distributed power source, and a commercial power source,
wherein said first distributed power source is connected to said main power path at a connection point between a connection point of said commercial power source and said main power path and a connection point of said second distributed power source and said main power path,
said power distribution system further comprising a reverse power flow prevention circuit interposed in said main power path between the connection point of said first distributed power source and said main power path and the connection point of said second distributed power source and said main power path, and configured to interrupt said main power path in response to occurrence of excess power in said distributed power source.

2. A power distribution system as set forth in claim 1, wherein
said main power path includes an AC main power path adapted for supplying AC power to an AC load and a DC main power path adapted for supplying DC power to a DC load,
said power distribution system further comprising a power conversion circuit interposed between said AC main power path and said DC main power path, said power conversion circuit being configured to convert an alternate current supplied from said AC main power path to a direct current to be supplied to said DC main power path, and said first distributed power source being connected to said DC main power path without passing through said power conversion circuit.
